(19) United States
(12) Patent Application Publication
(10) Pub. No.: US 2026/0124703 A1
(43) Pub. Date: May 7, 2026

(54) DETECTION ASSEMBLY, LASER ASSEMBLY, AND LASER PROCESSING EQUIPMENT

(71) Applicant: Shenzhen Creality 3D Technology Co., Ltd., Shenzhen (CN)

(72) Inventors: Huilin LIU, Shenzhen (CN); Mingwen LI, Shenzhen (CN); Fayang CAO, Shenzhen (CN)

(73) Assignee: Shenzhen Creality 3D Technology Co., Ltd., Shenzhen (CN)

(21) Appl. No.: 19/117,501

(22) PCT Filed: Jun. 30, 2023
(86) PCT No.: PCT/CN2023/105253

§ 371 Date: Apr. 1, 2025

(30) Foreign Application Priority Data
Oct. 14, 2022 (CN) 202211262395.3

(51) Int. Cl. B23K 26/38; G01K 13/00; G01L 19/00

(52) U.S. Cl. CPC B23K 26/38; G01K 13/00; G01L 19/0092

(57) ABSTRACT

The present application relates to a technique field of laser processing, aiming to solve problem of lens defects or impurities affecting normal laser emission during laser processing or causing excessive absorption of laser energy by the lens. The application discloses a detection assembly, laser assembly, laser emission control method, and laser processing equipment. The detection assembly includes a first circuit board. The first circuit board includes a substrate and a temperature sensor. The substrate is provided with a first via allowing laser emitted by the laser generator to pass. The temperature sensor is positioned on a surface of the substrate outside the first via and is directly thermally or indirectly thermally coupled to a to-be-inspected lens located in a laser path of the laser generator. The beneficial effect of the present application is the ability to detect the temperature of the lens conveniently without affecting the laser emission.

### FIELD

The present application relates to the technical field of laser processing, particularly, relates to a detection assembly, a laser assembly, a laser emission control method of the laser assembly, and a laser processing equipment.

### BACKGROUND

In laser processing, lens defects such as surface wear, internal gas pores, or external impurities such as smoke or dust may affect normal laser emission in the laser beam path. This in turn affects the laser processing effect or causes the lens to receive too much laser energy due to the defects or impurities, eventually leading to problem of overheating of the lens or even the laser equipment.

For example, when a laser engraving machine is configured to process materials such as wood and paper, smoke and dust may be generated. When these impurities adhere to the surface of the lens in the machine, these impurities can cause damage to the laser emission, affecting the printing and cutting effect, and may also cause the lens to overheat and crack, rendering the laser assembly unable to function properly.

### SUMMARY

The present application discloses a detection assembly, a laser assembly, and a laser processing equipment, to solve problem of lens defects or impurities affecting normal laser emission during laser processing or causing excessive absorption of laser energy by the lens.

In one embodiment, a detection assembly is disclosed. The detection assembly is capable of detecting a temperature of a to-be-inspected lens of a laser assembly. The laser assembly includes a laser generator, and the detection assembly includes a first circuit board. The first circuit board includes a substrate and a temperature sensor. The substrate is provided with a first via allowing laser emitted by the laser generator to pass. The temperature sensor is positioned on a side surface of the substrate and is in an area outside the first via. The temperature sensor is directly thermally or indirectly thermally coupled to the to-be-inspected lens located in a laser path of the laser generator.

In an embodiment, the detection assembly includes a plurality of temperature sensors, including the temperature sensor, the plurality of temperature sensors is distributed in a circumferential direction of the first via at intervals.

In an embodiment, the detection assembly further includes a thermal conductive structure, the thermal conductive structure is annular and includes a second via, the second via corresponds to the first via, one side of the thermal conductive structure is thermally coupled to the temperature sensor and another side of the thermal conductive structure is thermally coupled to the to-be-inspected lens. Alternatively, the thermal conductive structure may be a thermal conductive silicone film.

In an embodiment, the detection assembly further includes a connection member, the first circuit board is connected to the laser generator through the connection member. Alternatively, the connection member can be a connecting screw that securely connects the first circuit board to the laser generator.

In an embodiment, the detection assembly further includes a mounting plate, the mounting plate is coupled with the laser generator and presses the to-be-inspected lens against the temperature sensor.

In an embodiment, the mounting plate includes a first surface and a second surface opposite to each other, the first surface is coupled with the laser generator, and the first surface is concaved to form a relief groove for receiving the substrate.

In an embodiment, the mounting plate further includes a first through-hole, the first through-hole is concaved from a bottom surface of the relief groove and extends through to the second surface, the first through-hole corresponds to the first via and allows the laser to pass through. A part of the first through-hole near the first circuit board is expanded to form a first reaming hole, the first reaming hole receives the to-be-inspected lens.

In an embodiment, the detection assembly includes an annular elastic gasket, the annular elastic gasket is placed in the first reaming hole, one side of the annular elastic gasket presses against a bottom surface of the first reaming hole, another side of the annular elastic gasket elastically presses the to-be-inspected lens against the first circuit board.

In an embodiment, the mounting plate includes an airflow channel. The mounting plate includes an air opening that is concaved from the bottom surface of the relief groove and connected to the airflow channel, the air opening is spaced from the first through-hole. The first circuit board includes an air pressure sensor, the air pressure sensor is positioned on the substrate; the substrate covers the air opening, and the air pressure sensor is located within the air opening to detect a pressure inside the airflow channel.

In an embodiment, the airflow channel is provided with an airflow inlet and an airflow outlet, the airflow inlet extends to the first surface, the airflow outlet communicates with a part of the first through-hole located on a side of the to-be-inspected lens away from the first circuit board.

In an embodiment, the mounting plate includes a base plate, a cover, and a plug. A lower surface of the base plate includes a recessed groove, and the cover is covered on the recessed groove, a communicating hole is defined on the cover, the communicating hole acts as the airflow inlet. The recessed groove and the relief groove are spaced apart, and a depth of the recessed groove is greater than that of the relief groove; a thru hole is defined on the base plate, the thru hole extends from a side surface of the base plate under the bottom surface of the relief groove and extends to a side of recessed groove, the thru hole laterally communicates with the first through-hole, and the thru hole acts as the airflow outlet. The air opening communicates with the thru hole, the plug seals an opening of the thru hole on the side surface of the base plate.

In an embodiment, the base plate includes a middle plate portion and heat dissipation fins, the middle plate portion is extended in a second direction, the heat dissipation fins are located on both sides of the middle plate portion in a first direction, the first direction and the second direction are perpendicular to each other, and the relief groove is defined on the middle plate portion. The recessed groove includes a first groove section and a second groove section, the first groove section is spaced apart from the relief groove in the first direction, and the first groove section is located between the relief groove and the heat dissipation fins on one side; an end of the second groove section is communicated with the first groove section, another end of the second groove section extends in the first direction to a corresponding communicating hole near a corner of the base plate. The thru hole extends in the first direction to pass through an underside of the relief groove, and the thru hole communicates the first groove section.

In an embodiment, the mounting plate includes a second through-hole, the second through-hole is concaved from the bottom surface of the relief groove and extends through to the second surface, the second through-hole is spaced apart from the first through-hole. The first circuit board further includes a flame sensor for detecting a presence of a flame, the flame sensor is positioned on the substrate and corresponded to the second through-hole. The laser assembly further includes a second lens, the second lens is positioned on a side of the second through-hole away from the laser generator, and the flame sensor corresponds to the second lens.

In an embodiment, the laser modular includes two flame sensors, and the two flame sensors are positioned on the substrate, and are adjacently spaced apart.

In one embodiment, a laser assembly is disclosed, the laser assembly includes the laser generator, a first fens, and the detection assembly. The laser generator is configured to emit laser. The first lens acts as the to-be-inspected lens, and the first lens is located in the laser path of the laser generator. The first lens is directly thermally or indirectly thermally coupled to the temperature sensor of the detection assembly.

In an embodiment, the laser assembly includes a cooling fan, a circuit board, a top plate, and a shell. The cooling fan is connected to a side of the laser generator away from the detection assembly. The circuit board is connected to a side of the cooling fan away from the laser generator, the circuit board is electrically connected to the first circuit board, and the circuit board receives and processes temperature signals sent by the first circuit board, and the circuit board controls the laser generator to emit laser based on the temperature signals. The top plate is spaced apart from the circuit board and connected to a side of the circuit board away from the cooling fan. The shell surrounds periphery of the circuit board, the cooling fan, the laser generator, and the detection assembly, an end of the shell is covered by the top plate.

In an embodiment, the detection assembly includes a mounting plate, the mounting plate is connected to an emission side of the laser generator, and the mounting plate includes a first through-hole allowing laser to pass, the mounting plate includes an exposed portion, the exposed portion protrudes beyond a side of the laser generator. An airflow channel is defined on the mounting plate, the airflow channel is provided with an airflow inlet and an airflow outlet, the airflow inlet extends to a side of the exposed portion facing the generator, the airflow outlet communicates with the first through-hole. The shell includes a guide duct along an axial direction of the shell, one end of the guide duct communicates with the airflow channel, and another end of the guide duct is configured to connect to a gas source. The laser assembly includes a nozzle, the nozzle includes an axial hole, the nozzle is connected to a side of the mounting plate away from the laser generator, and the axial hole corresponds to and communicates with the first through-hole, such that the laser is allowed to exit and an auxiliary laser processing gas is allowed to be sprayed through the airflow channel and the first through-hole.

Alternatively, a second reaming hole is defined on a side of the first through-hole closer to the second surface. The nozzle includes a mouth portion and a connecting portion. The connecting portion is connected to the second reaming hole. The connecting portion includes a channel hole that extends along a lateral direction of the connecting portion. One side of the channel hole connects to the axial hole, and another side of the channel hole connects to the airflow channel.

In an embodiment, the laser generator and the mounting plate include heat dissipation fins, the heat dissipation fins define heat dissipation channels, the heat dissipation channels are parallel to a direction of the laser emission of the laser generator. An air intake is defined on the top plate, a ventilation gap is defined on the circuit board, the air intake communicates with the heat dissipation channels through the ventilation gap, and the cooling fan generates a cooling airflow that enters from the air intake and passes through the ventilation gap and the heat dissipation channels.

In an embodiment, a portion of the shell corresponding to an exit of the laser is set as a protective observation window for observing emission of the laser and reducing an impact of the laser on eyes of an observer. The circuit board includes a power indicator light and a laser diode indicator light, the power indicator light indicates whether a normal power supply is available, the laser diode indicator light indicates whether a laser diode of the laser generator is emitting normally. A lens status indicator light is positioned on the circuit board, the lens status indicator light indicates corresponding level of dirtiness of the first lens determined by the circuit board based on temperature information. The shell includes an indicator light window, the indicator light window is made of a light-transmitting material and corresponds to the power indicator light, the laser diode indicator light, and the lens status indicator light.

In one embodiment, a laser processing equipment is disclosed. The laser assembly includes a displacement assembly and the laser assembly. The laser assembly is configured to emit cutting laser. The displacement assembly is drivingly connected to the laser assembly, and the displacement assembly drives the laser assembly to move.

In one embodiment, a laser assembly is disclosed, the laser assembly includes:
a generator for emitting a laser;
a first lens located in a laser path of the laser generator;
a first circuit board, comprising a substrate and a temperature sensor, a pressure sensor, and a flame sensor, the temperature sensor, the pressure sensor, and the flame sensor are respectively positioned on a side of the substrate away from the laser generator; the substrate is connected to an emission side of the laser generator; the substrate is provided with a first via allowing laser emitted by the laser generator to pass; the temperature sensor is positioned on a side surface of the substrate and is in an area outside the first via;
a mounting plate, comprising a first surface and a second surface, the first surface and the second surface are opposite to each other, the first surface is configured to couple with the emission side of the laser generator; the first surface includes an relief groove, the relief groove is configured to receive the substrate; the mounting plate includes a first through-hole, the first through-hole is concaved from a bottom surface of the relief groove and extends through to the second surface, the first through-hole corresponds to the first via and allows the laser to pass through; a part of the first through-hole near the first circuit board is expanded to form a first reaming hole, the first lens is disposed in the first reaming hole and is directly thermally or indirectly thermally coupled to the temperature sensor; an airflow channel is defined on the mounting plate, the airflow channel is configured to pass through laser processing auxiliary gas, the airflow channel communicates with the first through-hole, the mounting plate includes an air opening, the air opening is concaved from the bottom surface of the relief groove and connected to the airflow channel, the air opening is spaced from the first through-hole, and the substrate covers the air opening, the air pressure sensor is located within the air opening to detect a pressure inside the airflow channel; the mounting plate includes a second through-hole, the second through-hole is concaved from the bottom surface of the relief groove and extends through to the second surface, the second through-hole is spaced apart from the first through-hole, the flame sensor corresponds to the second through-hole, a second lens is positioned on a side of the second through-hole away from the laser generator, the flame sensor corresponds to the second through-hole and the second lens, for detecting the presence of a flame at a laser processing position;
a cooling fan connected to the side of the generator away from the mounting plate;
a second circuit board, the second circuit board is spaced apart and connected to a side of the cooling fan away from the laser generator, the second circuit board is electrically connected to the first circuit board, the second circuit board receives and processes temperature signals, air pressure signals, and flame status signals detected by the temperature sensor, the pressure sensor, and the flame sensor of the first circuit board, and obtains control signals; the second circuit board includes a lens status indicator light, an air pressure indicator light, and a flame status indicator light, the lens status indicator light indicates corresponding level of dirtiness of the first lens determined by the second circuit board based on temperature information, the air pressure indicator light indicates whether the air pressure in the airflow channel is within allowable range, the flame status indicator light indicates the presence of a flame at the laser processing position;
a third circuit board, the third circuit board is spaced apart and connected to a side of the second circuit board away from the cooling fan; the third circuit board is electrically connected to the laser generator and the second circuit board, and the third circuit board control the laser emission of the laser generator based on the control signals; the third circuit board includes a power indicator light and a laser diode indicator light, the power indicator light indicates whether a normal power supply is available, and the laser diode indicator light indicates whether a laser diode of the laser generator is emitting normally;
a top plate, the top plate is spaced apart and connected to a side of the third circuit board away from the second circuit board;
a shell, the shell surrounds periphery of the third circuit board, the second circuit board, the cooling fan, the laser generator, and the mounting plate, one end of the shell is covered by the top plate; the shell includes a guide duct along an axial direction of the shell, one end of the guide duct communicates with the airflow channel, and another end of the guide duct is configured to connect to a gas source; and
a nozzle, the nozzle includes an axial hole, the nozzle is connected to a side of the mounting plate away from the laser generator, and the axial hole corresponds to and communicates with the first through-hole, such that the laser is allowed to exit and the auxiliary laser processing gas is allowed to be sprayed through the airflow channel and the first through-hole.

In one embodiment, a laser emission control method of the laser assembly is disclosed, the laser emission control method of the laser assembly includes:
reading and processing temperature signals, air pressure signals, and flame status signals; and
if the temperature or temperature rise exceeds an allowable range, the air pressure signal is beyond an allowable range, or the presence of flame is detected, prohibiting the laser generator from emitting laser, and sending an indication signal and/or an alarm signal; otherwise, allowing the laser generator to emit laser.

In one embodiment, a laser emission control system for the laser assembly is disclosed. The laser emission control system includes a processor, a controller, and a sensor module. The sensor module includes a temperature sensor, a pressure sensor, and a flame sensor. The temperature sensor is capable of detecting the temperature information of the first lens, the pressure sensor is capable of detecting the pressure information of the air flow channel, and the flame sensor is capable of detecting the presence status information of the flame. The sensor module is electrically connected to the processor for transmitting the temperature information, pressure information, and flame existence status information to the processor. The processor determines whether the temperature or temperature rise of the first lens is within the allowable range, whether the pressure of the air flow channel is within the allowable range, and whether there is a flame based on the temperature information, pressure information, and flame existence status information. If the temperature or temperature rise of the first lens is within the allowable range, the pressure of the air flow channel is within the allowable range, and there is no flame, a control signal allowing the laser emission is sent to the controller; if the temperature or temperature rise of the first lens is not within the allowable range, the pressure of the air flow channel is not within the allowable range, or there is a flame, a control signal prohibiting the laser emission is sent to the controller.

In an embodiment, the laser emission control system for the laser assembly includes an alarm component, and the alarm component is electrically connected to the processor. When the temperature or temperature rise of the first lens is not within the allowable range, the pressure of the air flow channel is not within the allowable range, or there is a flame, the processor controls the alarm component to send an alarm signal.

In an embodiment, the laser emission control system for the laser assembly includes a power supply component, and the power supply component is configured to supply power to the processor, the sensor module, the controller, and the alarm component.

### BRIEF DESCRIPTION OF THE DRAWINGS

Many aspects of the disclosure can be better understood with reference to the following drawings. The drawings in the following description are some embodiments of the present disclosure. For those of ordinary skill in the art, other drawings can be obtained based on these drawings without creative work.

FIG. 1 is a schematic view of a laser assembly of the present application.

FIG. 2 is a partial sectional view of the laser assembly in FIG. 1, structures behind a protective observation window and an indicator light window are shown in dashed lines.

FIG. 3 is another perspective view of a shell and the protective observation window of the laser assembly in FIG. 1.

FIG. 4 is a rear view of the laser assembly in FIG. 1 without the shell.

FIG. 5 is a schematic view of a laser generator, a thermal conduction structure, and a first lens in the present application.

FIG. 6 is a schematic view of a partial structure of the laser assembly in FIG. 4.

FIG. 7 is an explosion view of the structure of FIG. 6.

FIG. 8 is a top view of the structure of FIG. 6.

FIG. 9 is a sectional view of the structure of FIG. 8 along line A-A.

FIG. 10 is a sectional view of the structure of FIG. 8 along line B-B.

FIG. 11 is a sectional view of the structure of FIG. 6 along line C-C.

FIG. 12 is a schematic view of a laser processing equipment in the present application.

FIG. 13 is a flowchart of laser emission control method for the laser assembly in the present application.

FIG. 14 is a schematic diagram of a laser emission control system for the laser assembly in the present application.

### DESCRIPTION OF MAIN COMPONENTS OR ELEMENTS

Laser assembly 100; laser generator 10; first lens 11; to-be-inspected lens 11a; detection assembly 12; cooling fan 13; second circuit board 14; third circuit board 15; top plate 16;
shell 17; nozzle 18; first circuit board 19; mounting plate 20; heat dissipation fins 21a, 21b;
temperature sensor 22; pressure sensor 23; flame sensor 24; substrate 25; thermal conductive structure 26; annular elastic gasket 27; connection member 28a, 28b; base plate 29; cover 30; plug 31; second lens 32; raised pillar 33a, 33b, 33c; flexible circuit board 34;
connector 35; power interface 36; protective observation window 37; locking screw 38;
lens status indicator light 39; air pressure indicator light 40; flame status indicator light 41;
power indicator light 42; first laser diode indicator light 43; second laser diode indicator light 44; indicator light window 45; guide duct 46; long screw 47; mouth portion 48;
connecting portion 49; connecting head 50; circuit board 51; relief groove C1; recessed groove C2; first groove section C21; second groove section C22; heat dissipation channel F1; airflow channel F2; first via K1; first through-hole K2; first reaming hole K3; airflow inlet K4; airflow outlet K5; air opening K6; communicating hole K7; thru hole K8; second through-hole K9; axial hole K10; second reaming hole K11; air intake K13; ventilation gap K14; second via K15; channel hole K16; breach K17; first direction Y1; second direction Y2; first surface P1; second surface P2; laser processing equipment 300; displacement assembly 310; laser emission control system 500; processor 510; controller 520; sensing module 530; alarm indication module 540; power supply component 550.

### DETAILED DESCRIPTION

In order to better understand the above purposes, features and advantages of embodiments of the application, the application is described below in combination with the drawings and specific embodiments. It should be noted that, in the case of no conflict, the features in the embodiments of the present application can be combined with each other.

Many specific details are described in the following description to understand the embodiments of the application. The described embodiments are only part of the embodiments of the application, not all of them.

Unless otherwise defined, all technical and scientific terms used herein have the same meanings as those commonly understood by those skilled in the technical field belonging to the embodiments of the application. The terms used in the specification of the application herein are only for the purpose of describing specific embodiments, and are not intended to limit embodiments of the application.

The following specific embodiments will further explain the embodiments of the application in combination with the above drawings.

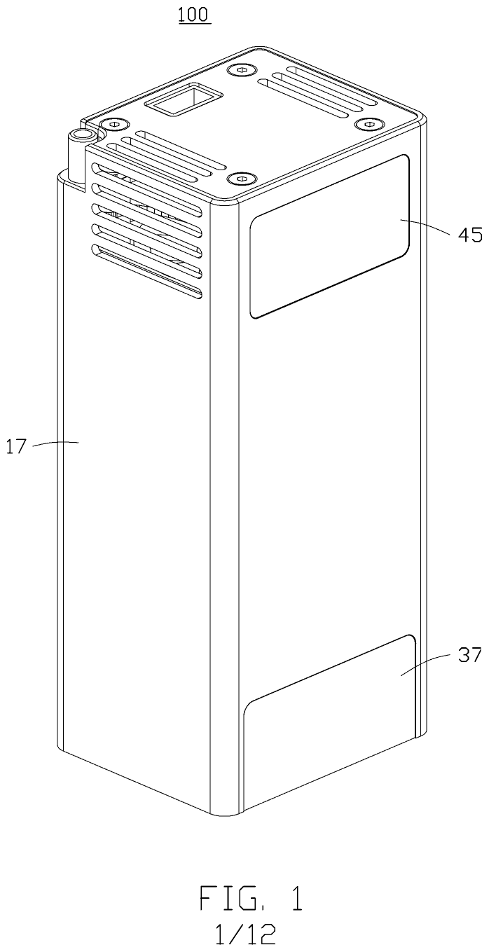

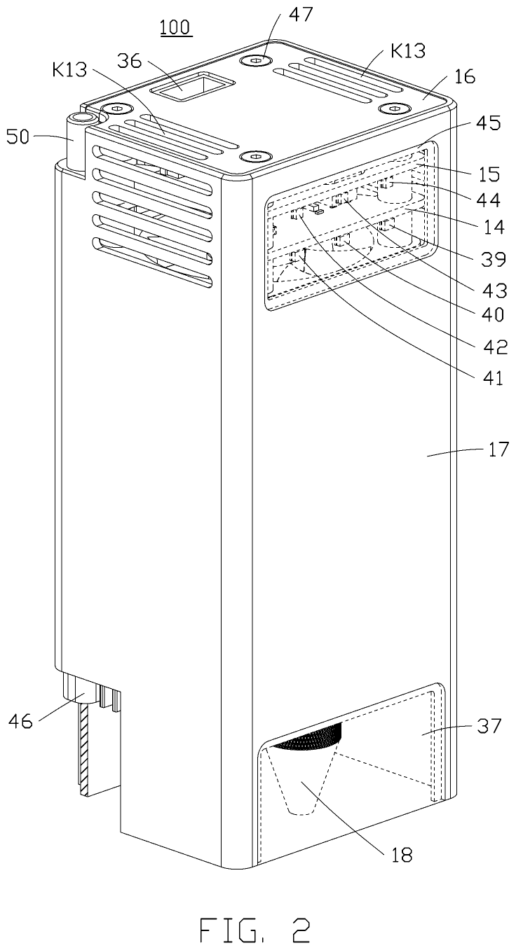

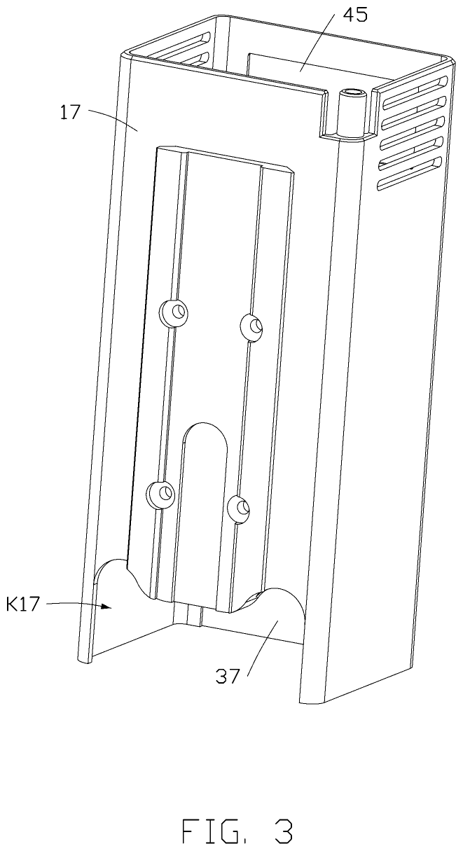

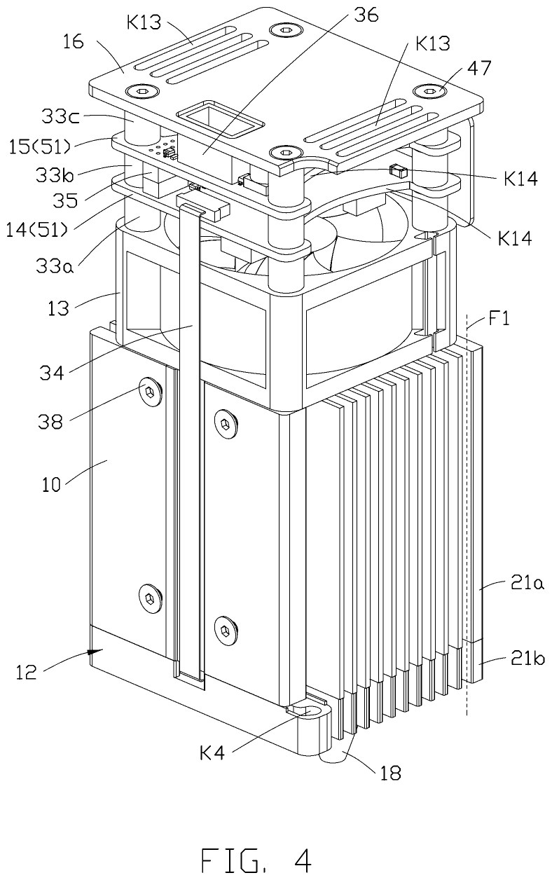

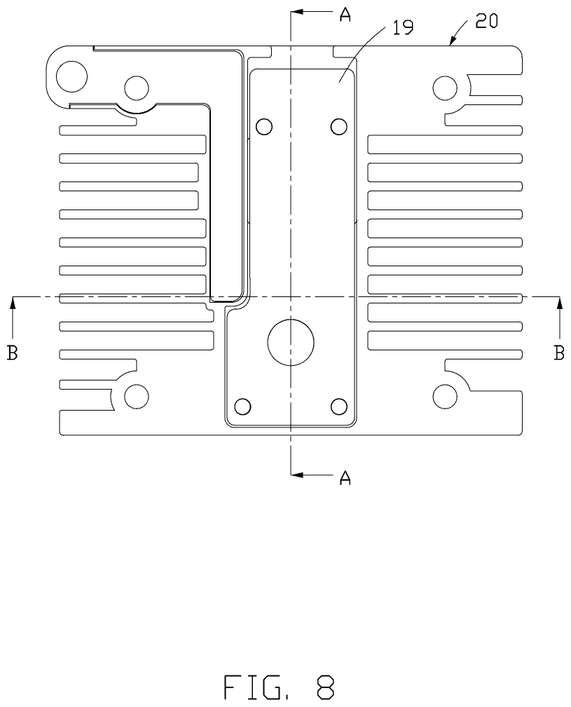

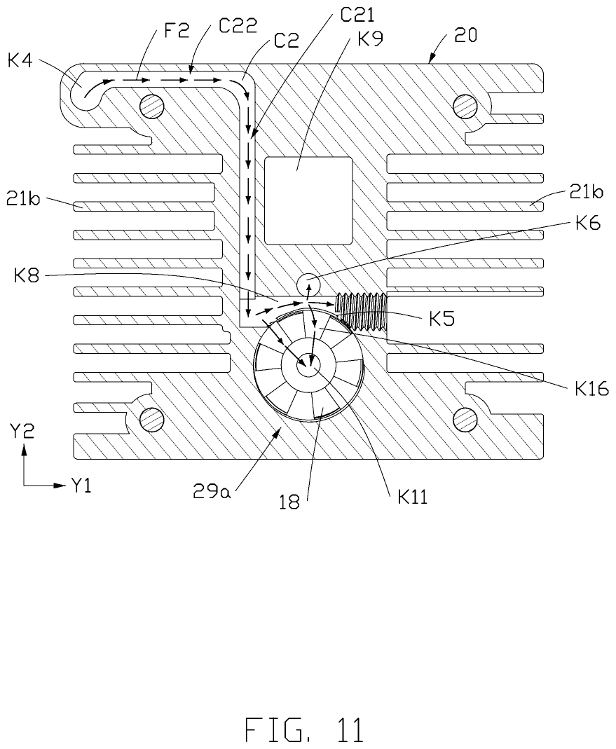

FIGS. 1 to 11 show a specific embodiment of a laser assembly 100 in the present application.

The laser assembly 100 disclosed in the embodiment is capable of being used for laser engraving, laser cutting, laser welding, laser punching, laser heat treatment, laser surface modification (such as laser annealing, laser quenching, laser alloying, laser cladding), laser 3D printing, or other known laser processing fields, as well as other fields such as laser detection and laser imaging.

Referring to FIGS. 1 to 6, the laser assembly 100 discloses in the embodiment includes a laser generator 10, a first lens 11, a detection assembly 12, a cooling fan 13, a second circuit board 14, a third circuit board 15, a top plate 16, a shell 17, and a nozzle 18. The detection assembly 12 includes a first circuit board 19 and a mounting plate 20.

The laser generator 10 is configured to emit laser. The laser generator may be known lasers such as solid-state lasers, CO₂ lasers or other common lasers, without limitation. In the embodiment, Alternatively, a middle portion of the laser generator 10 is a core part for generating laser (such as including a laser lamp that can be energized to generate laser). Heat dissipation fins 21a are provided on both sides of the core part. The heat dissipation fins define heat dissipation channels F1 that run parallel to a direction of the laser emission of the laser generator 10. In other embodiments, the heat dissipation fins 21a can be omitted directly where allowed, or other heat dissipation methods (such as liquid cooling) can be used as alternatives, without limitation.

The first lens 11 acts as a to-be-inspected lens 11a and is placed on the optical path of the laser. For example, the first lens 11 may be a protective lens configured to protect the laser generator 10 at the emission position to prevent external contaminants (such as dust, splatters generated during laser processing, etc.) from damaging the laser generator 10. In other embodiments, the first lens 11 can also be an internal lens of the laser generator 10. For example, the first lens 11 can be a constitutive lens in an optical lens group of the laser generator 10. In this case, the detection assembly 12 is capable of detecting internal parameters (such as temperature) of the laser generator 10. In addition, in one embodiment, the temperature of the first lens 11 is detected, and level of dirtiness or damage of the first lens 11 is determined based on the detected temperature or temperature rise of the first lens 11, which is then configured to control the laser emission of the laser generator 10. For example, when the temperature or temperature rise of the first lens 11 exceeds an allowable range, the level of dirtiness or damage of the first lens 11 is determined to be high. At this time, laser emission of the laser generator 10 is not allowed to avoid reduction of laser emission quality or high-temperature damage of components of the laser assembly 100. This protection function is particularly important when a laser power of the laser generator 10 is relatively high, as it reduces potential safety hazards caused by the increase in laser power. The specific structure or material of the first lens 11 can be set as needed, for example, a quartz flat window lens can be used.

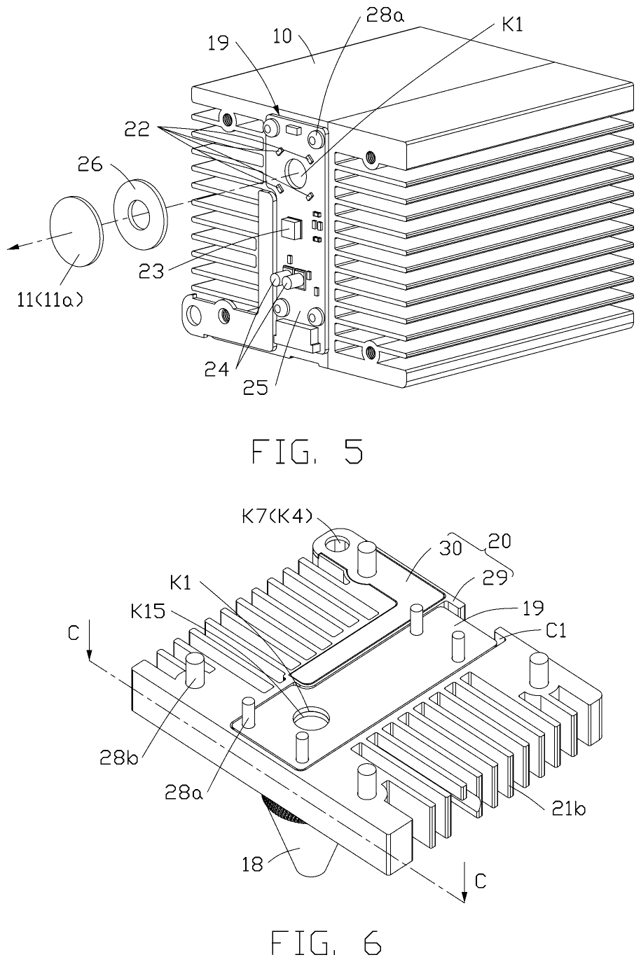

Referring to FIG. 5, the first circuit board 19 can be a printed circuit board or other form of circuit board. In one embodiment, the first circuit board 19 includes a substrate 25, a temperature sensor 22, a pressure sensor 23, and a flame sensor 24. The temperature sensor 22, the pressure sensor 23, and the flame sensor 24 are respectively positioned on a side of the substrate 25 away from the laser generator 10. The substrate 25 is connected to an emission side of the laser generator 10. For example, the substrate 25 is connected to the laser generator 10 through a connection member 28a (such as a connecting screw). Alternately, a lamp holder for mounting the laser lamp of the laser generator 10 is also locked and installed by the connection member 28a. In other embodiments, the substrate 25 and the laser generator 10 can also be connected by bonding, snap fitting, or other connection methods. The substrate 25 is provided with a first via K1, which allows the laser emitted by the laser generator 10 to pass. A laser emission direction is indicated by the arrow shown in FIG. 5. The temperature sensor 22 is positioned on a side surface of the substrate 25 and is located in an area outside the first via K1. The area on the side surface of the substrate 25 (shown in the FIG. as the side away from the laser generator 10) located outside the first via K1 can be a circular area concentric with the first via K1 or any other shape. In one embodiment, the temperature sensor 22 can be a thermistor or any other form capable of acquiring temperature information of the first lens 11. The temperature information can be directly processed or pre-processed on the first circuit board 19, or can be transmitted to other processing units of the laser assembly 100 (such as a section on the second circuit board 14 used for data processing), which is not limited here.

As shown in FIG. 5, the detection assembly 12 includes four temperature sensors 22. The four temperature sensors 22 are evenly distributed in a circumferential direction of the first via K1. In other embodiment, quantity of temperature sensors 22 can be one or other numbers, and the distribution of the temperature sensors 22 can be either evenly or unevenly distributed. The distance from a plurality of temperature sensors 22 to the center of the first via K1 can be equal or unequal. When they are unequal, the temperature detected by the plurality of temperature sensors 22 can indicate temperature at different distances from the first lens 11 to the center of the first via K1.

In one embodiment, the temperature sensors 22 can be analog sensors, digital sensors, or other forms of sensors.

Referring to FIGS. 6-10, in one embodiment, the mounting plate 20 includes a first surface P1 and a second surface P2. The first surface P1 and the second surface P2 are opposite to each other. The first surface P1 is configured to couple with an emission side of the laser generator 10. The first surface P1 includes a relief groove C1, the relief groove C1 is configured to receive the substrate 25. The mounting plate 20 includes a first through-hole K2, which is concaved from a bottom surface of the relief groove C1 and extends through to the second surface P2. The first through-hole K2 can be a round hole, a square hole, or other shapes. The first through-hole K2 corresponds to the first via K1 and allows the laser to pass through it. It should be noted that all the holes on the laser path are coaxially set. In other embodiments, if there are additional optical elements (such as reflector mirrors, refractive mirrors, etc.) on the laser path that change the direction of the laser path, the holes on the laser path may not be coaxial.

In addition to using the accommodating groove C1 on the mounting plate 20 to accommodate the substrate 25 of the first circuit board 19, in other embodiments, a positioning structure (such as a slot) can be set on the laser generator 10 to receive the first circuit board 19, or a gap can be defined between the laser generator 10 and the mounting plate 20 to accommodate the first circuit board 19. This is not limiting, and other methods of accommodating the first circuit board 19 can also be used as needed.

In one embodiment, a part of the first through-hole K2 near the first circuit board 19 is expanded to form a first reaming hole K3. The first lens 11 is disposed in the first reaming hole K3 and is directly thermally or indirectly thermally coupled to the temperature sensor 22. Direct thermal coupling here means that the first lens 11 is in direct contact with the temperature sensor 22, while indirect thermal coupling means that it is thermally coupled to the temperature sensor 22 via other thermal conductive structures 26.

By defining the first via K1 on the substrate 25 and placing the temperature sensor 22 on outside area of the first via K1, the detection assembly 12 in the present application is capable of conveniently detecting the temperature of the to-be-inspected lens 11a (such as the first lens 11) on the laser path of the laser generator 10, and level of dirtiness or damage to the lens can be determined, without affecting the laser emission, and the structure of detection assembly 12 is simple and reasonable.

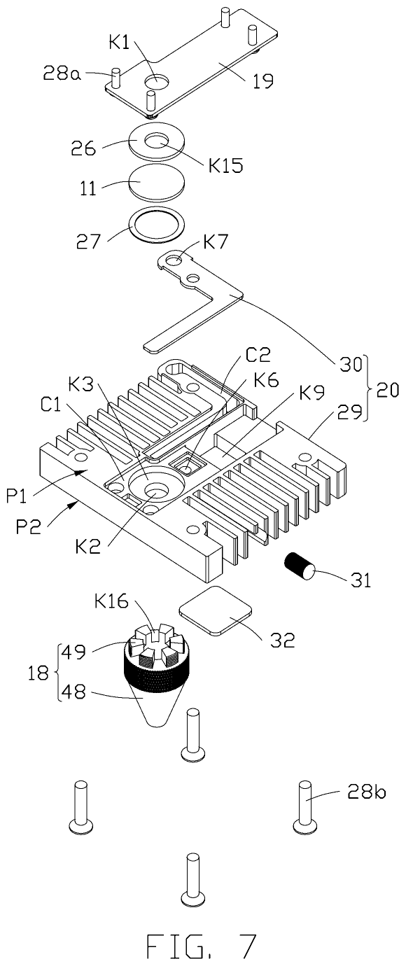

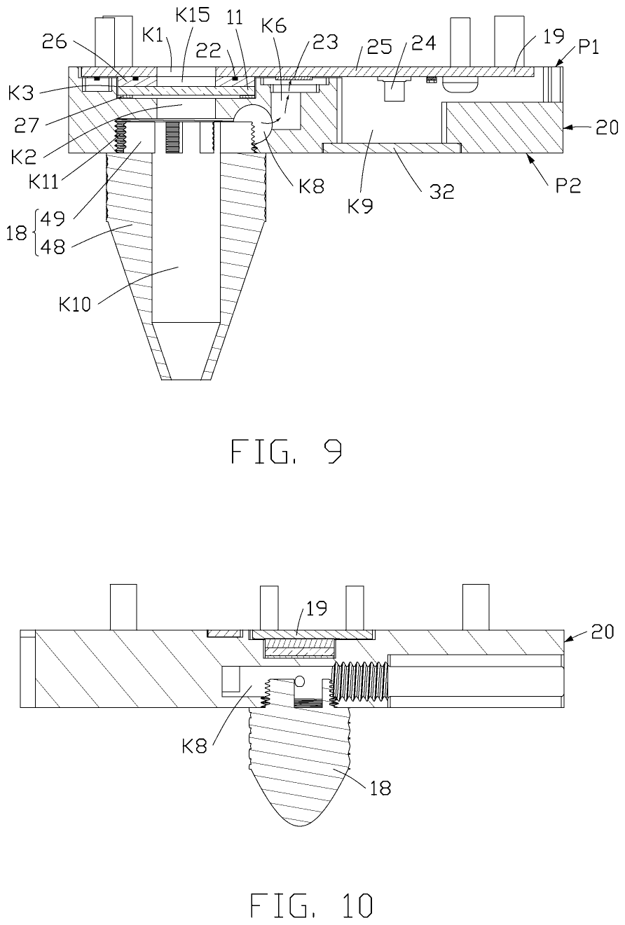

In one embodiment, indirect thermal coupling is applied. As shown in FIG. 7 and FIG. 9, the detection assembly 12 includes a thermal conductive structure 26 (such as a thermal conductive silicone film). The thermal conductive structure 26 is annular and includes a second via K15. The second via K15 is corresponded to the first via K1, which allows the laser to pass. One side of the thermal conductive structure 26 is thermally coupled to the temperature sensor 22 (directly or indirectly), and the other side of the thermal conductive structure 26 is thermally coupled to the first lens 11 (directly or indirectly). Alternatively, one side of the thermal conductive structure 26 can be coated with adhesive to attach to the first circuit board 19 and cover at least the area where the temperature sensor 22 is located, while the other side of the thermal conductive structure 26 can be in contact with the first lens 11 without being glued, making it easier to remove the lens for cleaning or replacement. In other embodiment, the thermal conductive structure 26 can also be provided with adhesive on both sides or without adhesive on both sides. In one embodiment, an annular thermal conductive silicone film is used as the thermal conductive structure 26. Its soft material is capable of providing good wrapping contact and cushioning for the temperature sensor 22, and the annular design retains the optical path while facilitating transfer of heat from the first lens 11 to the temperature sensor 22. Moreover, the annular thermal conductive silicone film helps to seal the first via K1 to enhance protection of output channel of the laser generator 10.

In other embodiment, thermal conduction form of the thermal conductive structure 26 may be other forms beyond a thermal conductive silicone film, including solid, liquid, gel or combination forms, without being limited to any particular form.

In an optional embodiment, the detection assembly 12 further includes an annular elastic gasket 27. The annular elastic gasket 27 is placed in the first reaming hole K3. One side of the annular elastic gasket 27 presses against a bottom surface of the first reaming hole K3, while the other side of the annular elastic gasket 27 elastically presses the first lens 11 against the first circuit board 19. In an assembly state, the annular elastic gasket 27 is in a compression state to elastically press the first lens 11 tightly against the first circuit board 19 or the thermal conductive structure 26. The annular elastic gasket 27 is capable of acting as a buffer and protect the first lens 11.

In one embodiment, the mounting plate 20 and the first circuit board 19 are respectively connected to the laser generator 10 using a connection member 28b (such as connecting screws), and there is no other fixing method between the mounting plate 20 and the first circuit board 19. Therefore, when the first lens 11 or the annular elastic gasket 27 needs to be replaced or cleaned, it is only necessary to remove the mounting plate 20 to remove the first lens 11 or the annular elastic gasket 27 from the first reaming hole K3, without having to dismantle the first circuit board 19, which is convenient to operate.

In the present disclosure, the detection assembly 12 adopts direct or indirect contact lens contamination detection scheme, which has advantages of low cost, small size, and simple production and assembly. During working process of the laser assembly 100, when smoke and dust generated during the cutting of materials such as wood accumulate on the protective lens surface over a long period of time, dirt on the lens surface will cause a loss of laser emission and be converted into heat, resulting in an increase in lens temperature. When an abnormal temperature or temperature rise of the lens is detected (for example, temperature rise is set as >0.15° C./S), it can be determined that the first lens 11 is dirty beyond the allowable value, and timely indicate to shut down the laser emission and feedback an alarm message, prompting the user to clean or replace the lens, which avoids irreversible damage such as lens cracking caused by lens contamination, and ensures processing effect of the laser assembly 100.

Referring to FIG. 11, in one embodiment, the mounting plate 20 includes an airflow channel F2 (as indicated by the arrow flow in FIG. 11), which is configured to pass through the laser processing auxiliary gas (such as laser cutting auxiliary gas), and the airflow channel F2 communicates with the first through-hole K2. The use of the laser processing auxiliary gas, such as the use of some laser cutting auxiliary gases, is capable of improving cutting thickness, reduce kerf widths, and improve pollutant accumulation on the lens and cutting surface. The specific auxiliary gas can be selected based on the laser processing technology or other needs. The airflow channel F2 is provided with an airflow inlet K4 and an airflow outlet K5. The airflow inlet K4 extends to the first surface P1 of the mounting plate 20, and the airflow outlet K5 communicates with a part of the first through-hole K2 located on a side of the first lens 11 away from the first circuit board 19, so that the auxiliary gas and laser flow out coaxially. In other embodiment, the auxiliary gas and laser can also be designed to flow out in different axes.

The mounting plate 20 includes an air opening K6 that is concaved from the bottom surface of the relief groove C1 and communicates with the airflow channel F2. The air opening K6 is spaced from the first through-hole K2, and the substrate 25 covers the air opening K6. The air pressure sensor 23 is located within the air opening K6 to detect a pressure inside the airflow channel F2. By detecting the air pressure, the laser assembly 100 is capable of promptly detecting and handle unexpected stoppage or pressure attenuation of the air source pump during use, and issue an alarm prompt, avoiding inconsistencies in air pressure that could affect required process parameters and affect the laser processing effect, ultimately improving the user experience. For example, if the air pressure at the air opening K6 is detected to be more than ±10% different from a preset value, it is determined as air pressure abnormality. At this time, if the laser assembly 100 receives an instruction to emit laser, the laser assembly 100 will sound an alarm and prevent laser emission.

In one embodiment, some groove/hole structures are defined on the mounting plate 20 to form the airflow channel F2. As shown in FIG. 7 to FIG. 11, the mounting plate 20 includes a base plate 29, a cover 30 and a plug 31. A lower surface of the base plate 29 includes a recessed groove C2, and the cover 30 is covered on the recessed groove C2. A communicating hole K7 is defined on the cover 30, and the communicating hole K7 communicates with the recessed groove C2 and acts as the airflow inlet K4. Alternatively, the cover 30 can be made of rubber material. The recessed groove C2 and the relief groove C1 are spaced apart, and a depth of the recessed groove C2 is greater than that of the relief groove C1. The recessed groove C2 and the relief groove C1 are spaced apart to avoid affecting the output and/or sensing of various sensing structures in the area, as the first circuit board 19 is placed in the relief groove C1. A thru hole K8 is defined on the base plate 29. The thru hole K8 extends from a side surface of the base plate 29 under a bottom of the relief groove C1 (without intersecting with the bottom surface of the relief groove C1) and extends to a side of recessed groove C2. The thru hole K8 is laterally communicates with the first through-hole K2, and the thru hole K8 acts as the airflow outlet K5. The air opening K6 communicates with the thru hole K8. Therefore, an airflow entering the thru hole K8 will enter the air opening K6, arrows in FIG. 9 or FIG. 11 indicates the airflow, so that the air pressure at the air opening K6 represents the air pressure inside the airflow channel F2. The plug 31 seals an opening of the thru hole K8 on the side surface. A threaded connection is applied between the plug 31 and the thru hole K8, to facilitate machining of the desired airflow channel F2.

In one embodiment, alternatively, the base plate 29 of the mounting plate 20 includes left, middle, and right parts arranged in a first direction Y1, which are the middle plate portion 29a extending in a second direction Y2 and the heat dissipation fins 21a located on both sides of the middle plate portion 29a in the first direction Y1. The first direction Y1 and the second direction Y2 are perpendicular to each other, with the first direction Y1 being the horizontal direction and the second direction Y2 being the vertical direction. The middle plate portion 29a includes the relief groove C1 and structures such as the first through-hole K2 and the air opening K6 located inside of the relief groove C1.

Alternatively, the recessed groove C2 includes a first groove section C21 and a second groove section C22. The first groove section C21 is spaced apart from the relief groove C1 in the first direction Y1, and the first groove section C21 is located between the relief groove C1 and the heat dissipation fins 21a on one side. An end of the second groove section C22 is communicated with the first groove section C21, another end of the second groove section C22 extends in the first direction Y1 to a corresponding communicating hole K7 near a corner of the base plate 29. The thru hole K8 extends in the first direction Y1 to pass through the underside of the relief groove C1, and is communicated to the first groove section C21. In other embodiments, shape of the recessed groove C2 may be designed based on other requirements, but attention should be paid to avoiding the laser beam.

The heat dissipation fins 21b on the left and right sides have a large cooling area and form heat dissipation channels F1 that passes through the mounting plate 20 in a thickness direction of the mounting plate 20, which is connected to the corresponding heat dissipation channels F1 on the heat dissipation fins 21a of the laser generator 10 to allow the cooling airflow to take away heat. The cooling structure of the laser generator 10 and the mounting plate 20 are examples, and structures corresponding to other cooling forms, such as air cooling, liquid cooling, or other cooling forms, can also be applied to the mounting plate 20.

The mounting plate 20 includes a second through-hole K9 that is concaved from the bottom surface of the relief groove C1 and extends through to the second surface P2. The second through-hole K9 can be a square hole, a round hole, or a hole of any other shape. The second through-hole K9 is spaced apart from the first through-hole K2. The flame sensor 24 corresponds to the second through-hole K9, and a second lens 32 is positioned on a side of the through-hole K9 away from the laser generator 10. The flame sensor 24 corresponds to the second through-hole K9 and the second lens 32, for detecting the presence of a flame at the laser processing position. In one embodiment, the flame sensor 24 can be an optical sensor or a thermal sensor, which is capable of obtaining optical image information or thermal image information of a target area (such as the laser processing area), and by searching for flame characteristic information in obtained information, it can be determined whether there is a flame in the target area. Specifically, the flame sensor 24 of a known model or function can be used, and will not be described here. Alternatively, the laser assembly 100 includes two flame sensors 24 adjacent to each other and positioned on the substrate 25, and two sets of information can be obtained through the two adjacent flame sensors 24, which improves accuracy of flame detection. As the frequency bands of sunlight overlap with those of the flame emission, it is easy to generate false alarms under sunlight environment, which affects user experience. The flame detection scheme proposed in the present application is capable of distinguishing sunlight interference and reduce the possibility of misjudgment.

The hardware and software processing of the flame sensor 24 has been upgraded to ensure the flame detection alarm at the lowest cost, while also solving the problem of false alarms due to sunlight interference, effectively improving user experience.

In one embodiment, from an overall perspective, the first through-hole K2, air opening K6, and second through-hole K9 are sequentially arranged on the inner side of the relief groove C1, and the corresponding temperature sensor 22, air pressure sensor 23, and flame sensor 24 are arranged along the substrate 25. When the first circuit board 19 and the mounting plate 20 are respectively installed on the laser generator 10, the relative position of the first circuit board 19 and the mounting plate 20 is determined, so that the temperature sensor 22, air pressure sensor 23, and flame sensor 24 correspond to the first through-hole K2, air opening K6, and second through-hole K9, respectively, to achieve the detection of corresponding parameters or information. In other embodiments, other arrangement methods can also be applied, and this is not limited herein.

In one embodiment, the cooling fan 13, the second circuit board 14, the third circuit board 15, and the top plate 16 are sequentially connected to a side of the laser generator 10 away from the mounting plate 20. Alternatively, the cooling fan 13 can be directly connected to the laser generator 10, and spacers such as raised pillars 33a, 33b, 33c can be configured to provide spaced support between the second circuit board 14 and the cooling fan 13, between the third circuit board 15 and the second circuit board 14, and between the top plate 16 and the third circuit board 15, and long screws 47 and other connection structures can be configured to connect to the laser generator 10 to leave a safe distance between the second circuit board 14 and the cooling fan 13, between the third circuit board 15 and the second circuit board 14, and between the top plate 16 and the third circuit board 15 to avoid short circuits in the circuit or damage to components caused by contact, and also facilitate the cooling of the second circuit board 14 and the third circuit board 15. In other embodiment, the positions and order of the cooling fan 13, the second circuit board 14, the third circuit board 15, and the top plate 16 can be set based on other requirements, and are not limited here.

In one embodiment, the cooling fan 13 may be a common fan, as long as it is capable of generating a cooling airflow. In other embodiments, the cooling fan 13 may not be provided, and other methods such as liquid cooling can be used to achieve cooling.

Alternatively, the second circuit board 14 is spaced apart and connected to a side of the cooling fan 13 away from the laser generator 10. The second circuit board 14 is electrically connected to the first circuit board 19. For example, the second circuit board 14 is electrically connected to the first circuit board 19 via a flexible circuit board 34. The second circuit board 14 receives and processes temperature signals, air pressure signals, and flame status signals detected by the temperature sensor 22, the pressure sensor 23, and the flame sensor 24 of the first circuit board 19, thus obtaining control signals for controlling the operation of the laser generator 10.

Alternatively, the third circuit board 15 is spaced apart and connected to a side of the second circuit board 14 away from the cooling fan 13, for example, the spaced connection is achieved by the raised pillar 33b. The third circuit board 15 is electrically connected to the laser generator 10 and the second circuit board 14, and the third circuit board 15 controls the laser emission of the laser generator 10 based on the control signals. The electrical connection between the third circuit board 15 and the second circuit board 14 is achieved by a board-to-board connector 35. The control signal line of the laser generator 10 is soldered to the third circuit board 15 to achieve the electrical connection between the third circuit board 15 and the laser generator 10. Alternatively, a power interface 36 can also be provided on the third circuit board 15 for plugging in a power cord to achieve power supply. The power interface 36 can be exposed on the top plate 16 (for example, by defining a corresponding opening on the top plate 16) to facilitate insertion of the power cord, for supplying power to various electrical structures such as the first circuit board 19, the second circuit board 14, the third circuit board 15, the laser generator 10, the cooling fan 13, etc.

In other embodiments, a single circuit board 51 integrating the functions of the second circuit board 14 and third circuit board 15 can be used instead of the second circuit board 14 and third circuit board 15. The functions of the second circuit board 14 and third circuit board 15 can also be split into three or more small circuit boards, and are not limited here.

The top plate 16 is spaced apart and connected to a side of the third circuit board 15 away from the second circuit board 14.

The shell 17 surrounds periphery of the third circuit board 15, the second circuit board 14, the cooling fan 13, the laser generator 10, and the mounting plate 20. One end of the shell 17 is covered by the top plate 16. The top plate 16 and the shell 17 together serve as an outer shell of the laser assembly 100. Alternatively, a portion of the shell 17 corresponding to exit of the laser can be set as a protective observation window 37, for observing the emission of the laser and reducing impact of the laser on the eyes of an observer. In one embodiment, the protective observation window 37 is positioned at a position corresponding to an outlet of the nozzle 18, and the user can observe the laser emission status through the protective observation window 37. The protective observation window 37 can be made of known laser-specific protective materials to prevent the user from being harmed by excessive light when observing the laser emission. Alternatively, one side of the laser generator 10 can be adhered to one side wall of the shell 17, and mutually locked by locking screws 38.

In one embodiment, the nozzle 18 includes an axial hole K10. The nozzle 18 is connected to a side of the mounting plate 20 away from the laser generator 10, and the axial hole K10 corresponds to and communicates with the first through-hole K2, such that the laser is allowed to exit and the auxiliary laser processing gas is allowed to be sprayed through the airflow channel F2 and the first through-hole K2.

Alternatively, a second reaming hole K11 is defined on a side of the first through-hole K2 closer to the second surface P2. The nozzle 18 includes a mouth portion 48 and a connecting portion 49. The connecting portion 49 is connected to the second reaming hole K11. For example, the connecting portion 49 is connected to the second reaming hole K11 by threaded connection. The connecting portion 49 includes a channel hole K16 that extends along a lateral direction of the connecting portion 49. One side of the channel hole K16 communicates with the axial hole K10, and the other side of the channel hole K16 communicates with the thru hole K8 in the airflow channel F2, to guide the airflow out of the axial hole K10. Alternatively, the channel hole K16 is a radial hole that passes through the connecting portion 49 radially, and the connecting portion 49 includes a plurality of radial holes uniformly distributed along the circumferential direction of the connecting portion 49.

Alternatively, a breach K17 is defined on one side wall of the shell 17. In one embodiment, the breach K17 is defined on the side of the shell 17 corresponding to the protective observation window 37, for exhausting smoke-containing gas generated during laser processing in the space surrounded by the shell 17 and the mounting plate 20 where the nozzle 18 is located. In this way, the laser processing auxiliary gas sprayed from the axial hole K10 disperses the smoke generated during laser processing and blow the smoke out from the breach K17, reducing the impact on laser processing.

In one embodiment, alternatively, the laser assembly 100 further includes indicator lights for indicating some states of the laser assembly 100. For example, the second circuit board 14 includes a lens status indicator light 39, an air pressure indicator light 40, and a flame status indicator light 41. The lens status indicator light 39 indicates corresponding level of dirtiness of the first lens 11 determined by the second circuit board 14 based on temperature information. The air pressure indicator light 40 indicates whether the air pressure in the airflow channel F2 is within the allowable range. The flame status indicator light 41 indicates the presence of a flame at the laser processing position. The third circuit board 15 includes a power indicator light 42 and a laser diode indicator light. The power indicator light 42 indicates whether a normal power supply is available, and the laser diode indicator light indicates whether the laser diode of the laser generator 10 is emitting normally. In one embodiment, the laser assembly 100 includes two laser diode indicator lights, which are a first laser diode indicator light 43 and a second laser diode indicator light 44, for indicating the emitting status of the two laser diodes of the laser generator 10, respectively. Alternatively, the laser assembly 100 further includes an alarm, such as a buzzer, which can be controlled to emit an alarm signal when necessary.

The shell 17 includes an indicator light window 45. The indicator light window 45 is made of a light-transmitting material and corresponds to the power indicator light 42, the first laser diode indicator light 43, the second laser diode indicator light 44, the lens status indicator light 39, the air pressure indicator light 40, and the flame status indicator light 41. In this way, the user can observe and confirm the various working states of the laser assembly 100 through the indicator light window 45.

The indication and differentiation methods of the above indicator lights can be set based on needs.

For example, the indicator lights use LED lights, and their lamp beads use red-green dual-color lights, which are capable of displaying three colors of green, red, and orange by controlling the display.

The display colors of the above six indicator lights can be set as follows:
The power indicator light 42: the green light is on when normal power supply is available, and the light is off when there is no power supply;
The first laser diode indicator light 43: working indicator light for the first laser diode; the green light is on when emitting normally, and the light is off when not emitting;
The second laser diode indicator light 44: working indicator light for the second laser diode; the green light is on when emitting normally, and the light is off when not emitting;
The lens status indicator light 39: green light is on when the first lens 11 is not dirty, orange light is on when the first lens 11 is slightly contaminated, and red light is on when the first lens 11 is heavily contaminated or damaged;
The air pressure indicator light 40: green light is on when the air pressure in the airflow channel F2 is normal, orange light is on when the air pressure is weak, and red light is on when there is no air pressure;
The flame status indicator light 41: red light is on when a flame is detected, and green light is on when a flame is not detected.

For the above indicators, once the red light is on, it indicates that the system has detected a dangerous state. The system will sound an alarm through a buzzer and block the laser emission at the same time.

Alternatively, in one embodiment, the shell 17 includes a guide duct 46 along an axial direction of the shell 17. One end of the guide duct 46 communicates with the airflow channel F2, and the other end of the guide duct 46 is configured to connect to a gas source (not shown in the figure). As shown in figures, the shell 17 is roughly square, and the guide duct 46 is formed at a corner on the inner side of the shell 17. An upper end of the guide duct 46 forms an exposed connection head 50, which is convenient for connecting to the gas source. The gas supplied by the gas source flows through the guide duct 46 and the airflow channel F2 into a portion of the first through-hole K2 on the side of the first lens 11 away from the laser generator 10, and then sprays out from the nozzle 18 through the first through-hole K2 and the axial hole K10 of the nozzle 18. In this process, when the airflow flows through the first lens 11, the airflow blows the exposed surface of the first lens 11 (the side surface near the outlet of the nozzle 18) to achieve self-cleaning function of the first lens 11, and to prevent dirt (such as cutting dust splashed during laser processing) from adhering to the first lens 11, reducing the rate of dirt buildup on the first lens 11.

Alternatively, in one embodiment, the top plate 16 includes an air intake K13. The second circuit board 14 and third circuit board 15 includes ventilation gaps K14. The air intake 13 communicates with the heat dissipation channels F1 through the ventilation gaps K14. The cooling fan 13 generates a cooling airflow that enters from the air intake K13 and passes through the ventilation gaps K14 and the heat dissipation channels F1. In this way, during the operation of the laser assembly 100, the cooling fan 13 draws in cool air from the outside of the laser assembly 100 through the air intake K13. The air enters through the ventilation gaps K14 of the second circuit board 14 and third circuit board 15 and passes through the heat dissipation channels of the laser generator 10 and mounting plate 20, carrying away the heat generated by the laser generator 10, blowing out of the laser assembly 100 to achieve the cooling of the laser assembly 100.

In the above embodiment, the detection module 12 is capable of detecting temperature signals, air pressure signals, and flame status signals separately. In other embodiments, it is also possible to only implement the detection of one or two of these parameters, and discard the corresponding structural designs that are not required to detect. For example, the detection of air pressure signals can be cancelled, which means that the structure of the air pressure sensor 23 and the air opening K6 can be omitted. Another example is that the detection of flame status signals can be cancelled, and the flame sensor 24 and the second lens 32 can be omitted.

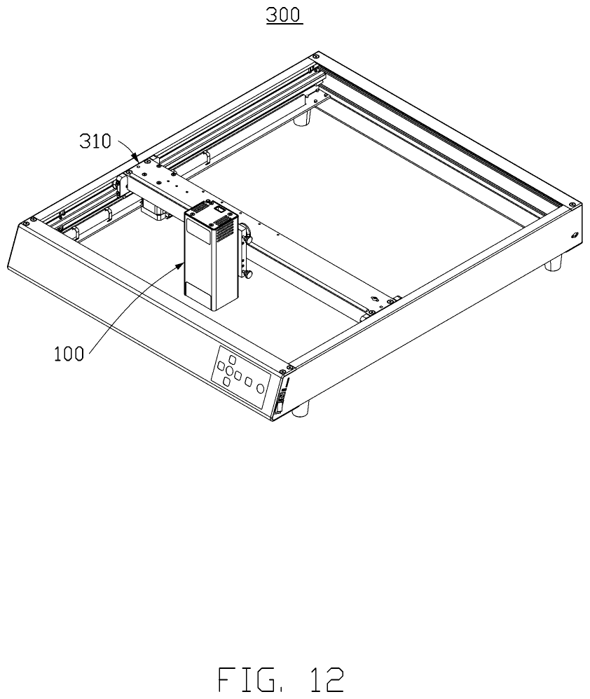

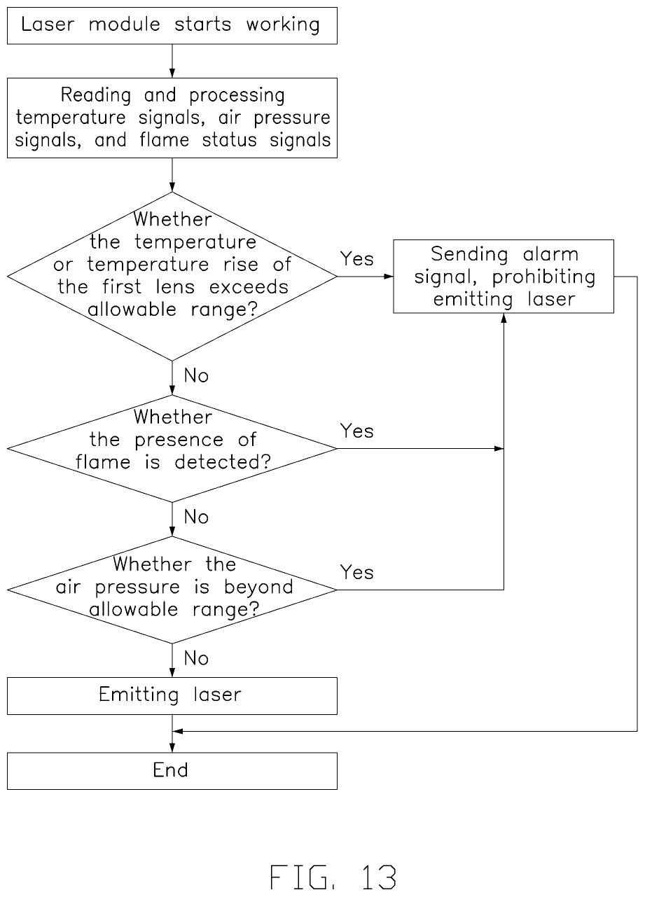

Referring to FIG. 12. in one embodiment, a laser processing equipment 300 is provided. Specifically, the laser processing equipment 300 is a laser cutting device, which includes a displacement assembly 310 and the laser assembly 100. The displacement assembly 310 is drivingly connected to the laser assembly 100, and the displacement assembly 310 drives the laser assembly 100 to move along a path for laser cutting processing.

The displacement assembly 310 can be set based on specific needs. In one embodiment, the laser assembly 100 emits laser along a Z-axis direction (i.e., the vertical direction in FIG. 12), and the displacement assembly 310 is a planar displacement mechanism that drives the laser assembly 100 to move in an X-axis direction and a Y-axis direction respectively. The X-axis, Y-axis, and Z-axis together constitute a spatial rectangular coordinate system.

In other embodiment, the laser assembly 100 can also be a laser processing equipment 300, that is used for laser operations other than cutting, without limitation. The displacement assembly 310 can also be a single-axis displacement assembly, a multi-axis displacement assembly, or a multi-degree-of-freedom robotic arm, which is not limited herein.

In other embodiments, the laser assembly 100 of the laser processing equipment 300 can also be fixed in place to achieve fixed-position laser processing.

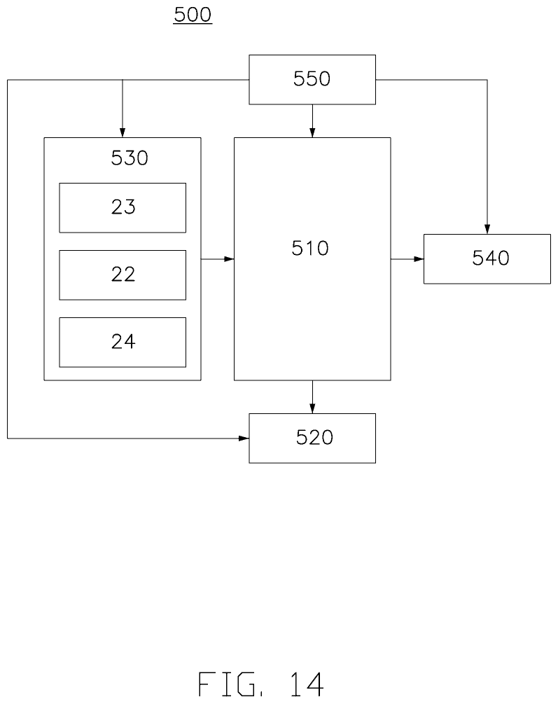

Referring to FIG. 13, the present application also discloses a laser emission control method for the laser assembly 100. The laser emission control method includes:
reading and processing temperature signals, air pressure signals, and flame status signals;
if the temperature or temperature rise exceeds the allowable range, the air pressure signal is beyond the allowable range, or the presence of flame is detected, the laser generator 10 is prohibited from emitting laser, and an indication signal and/or an alarm signal is sent. Otherwise, allow the laser generator 10 to emit laser.

Referring to FIG. 14, a laser emission control system 500 disclosed in the present application is an emission control part of the laser assembly 100. The laser emission control system 500 includes a processor 510, a controller 520, and a sensing module 530. The processor 510 can be positioned on the second circuit board 14, the controller 520 can be positioned on the third circuit board 15, and the sensing module 530 is positioned on the first circuit board 19.

The sensing module 530 includes the temperature sensor 22, the air pressure sensor 23, and the flame sensor 24. The temperature sensor 22 is capable of detecting the temperature information of the first lens 11, the air pressure sensor 23 is capable of detecting the air pressure information of the airflow channel F2, and the flame sensor 24 is capable of detecting the flame status information. The sensing module 530 is electrically connected to the processor 510 for transmitting temperature information, air pressure information, and flame presence status information to the processor 510.

The processor 510 is capable of determining whether the temperature or temperature rise of the first lens 11 is within the allowable range, whether the air pressure of the airflow channel F2 is within the allowable range, and whether the presence of flame is detected based on the temperature information, air pressure information, and flame presence status information. If the temperature or temperature rise of the first lens 11 is within the allowable range, the air pressure of the airflow channel F2 is within the allowable range, and there is no flame, a control signal allowing laser emission is sent to the controller 520. If the temperature or temperature rise of the first lens 11 is not within the allowable range, the air pressure of the airflow channel F2 is not within the allowable range, or there is a flame, a control signal prohibiting laser emission is sent to the controller 520.

Alternatively, the laser emission control system 500 further includes an alarm prompt module 540. The alarm prompt module 540 is electrically connected to the processor 510. The alarm prompt module 540 may include a buzzer for emitting an alarm sound.

When the temperature or temperature rise of the first lens 11 is not within the allowable range, the air pressure of the airflow channel F2 is not within the allowable range, or there is a flame, the processor 510 controls the alarm prompt module 540 to send an alarm signal.

Alternatively, the laser emission control system 500 further includes a power supply component 550. The power supply component 550 is configured to supply power to the processor 510, sensing module 530, controller 520, and alarm prompt module 540.

In summary, the detection assembly 12, laser assembly 100, laser emission control method, and laser processing equipment 300 of the present disclosure have a reasonable structural design and are capable of realizing detection of the lens status of the laser system (such as dirty status), auxiliary gas pressure, or flame presence status, which is beneficial to safe laser emission of the laser assembly 100.

The above embodiments are only configured to describe the technical solution of the embodiments of the application, not the limitations. Although the embodiments of the application have been described in detail with reference to the above exemplary embodiments, ordinary technicians in the art should understand that the technical solution of the embodiments of the application can be modified or replaced equivalently, which should not be divorced from the spirit and scope of the technical solution of the embodiments of the application.

1. A detection assembly capable of detecting a temperature of a to-be-inspected lens of a laser assembly, the laser assembly comprising a laser generator, the detection assembly comprising:
a first circuit board comprising a substrate and a temperature sensor, wherein the substrate is provided with a first via allowing laser emitted by the laser generator to pass, the temperature sensor is positioned on a side surface of the substrate and is in an area outside the first via, and the temperature sensor is directly thermally or indirectly thermally coupled to the to-be-inspected lens located in a laser path of the laser generator.

2. The detection assembly of claim 1, wherein
the detection assembly further comprises a plurality of temperature sensors, including the temperature sensor, the plurality of temperature sensors is distributed in a circumferential direction of the first via at intervals.

3. The detection assembly of claim 1, wherein
the detection assembly further comprises a thermal conductive structure, the thermal conductive structure is annular and comprises a second via, the second via corresponds to the first via, one side of the thermal conductive structure is thermally coupled to the temperature sensor and another side of the thermal conductive structure is thermally coupled to the to-be-inspected lens.

4. The detection assembly of claim 1, wherein
the detection assembly further comprises a connection member, the first circuit board is connected to the laser generator through the connection member.

5. The detection assembly of claim 1, wherein
the detection assembly further comprises a mounting plate, the mounting plate is coupled with the laser generator and presses the to-be-inspected lens against the temperature sensor.

6. The detection assembly of claim 5, wherein
the mounting plate comprises a first surface and a second surface opposite each other, the first surface is coupled with the laser generator, the first surface is concaved to form a relief groove for receiving the substrate.

7. The detection assembly of claim 6, wherein
the mounting plate further comprises a first through-hole, the first through-hole is concaved from a bottom surface of the relief groove and extends through to the second surface, the first through-hole corresponds to the first via and allows the laser to pass through, and
a part of the first through-hole near the first circuit board is expanded to form a first reaming hole, the first reaming hole receives the to-be-inspected lens.

8. The detection assembly of claim 7, wherein
the detection assembly further comprises an annular elastic gasket, the annular elastic gasket is placed in the first reaming hole, one side of the annular elastic gasket presses against a bottom surface of the first reaming hole, another side of the annular elastic gasket elastically presses the to-be-inspected lens against the first circuit board.

9. The detection assembly of claim 7, wherein,
the mounting plate further comprises an airflow channel,
the mounting plate further comprises an air opening that is concaved from the bottom surface of the relief groove and connected to the airflow channel, the air opening is spaced from the first through-hole, and
the first circuit board further comprises an air pressure sensor, the air pressure sensor is positioned on the substrate, the substrate covers the air opening, and the air pressure sensor is located within the air opening to detect a pressure inside the airflow channel.

10. The detection assembly of claim 9, wherein
the airflow channel is provided with an airflow inlet and an airflow outlet, the airflow inlet extends to the first surface, the airflow outlet communicates with a part of the first through-hole located on a side of the to-be-inspected lens away from the first circuit board.

11. The detection assembly of claim 10, wherein
the mounting plate further comprises a base plate, a cover, and a plug,
a lower surface of the base plate comprises a recessed groove, and the cover is covered on the recessed groove, a communicating hole is defined on the cover, the communicating hole acts as the airflow inlet,
the recessed groove and the relief groove are spaced apart, a depth of the recessed groove is greater than a depth of the relief groove, a thru hole is defined on the base plate, the thru hole extends from a side surface of the base plate under the bottom surface of the relief groove and extends to a side of recessed groove, the thru hole laterally communicates with the first through-hole, the thru hole acts as the airflow outlet, and
the air opening communicates with the thru hole, the plug seals an opening of the thru hole on the side surface of the base plate.

12. The detection assembly of claim 11, wherein
the base plate comprises a middle plate portion and heat dissipation fins, the middle plate portion is extended in a second direction, the heat dissipation fins are located on both sides of the middle plate portion in a first direction, the first direction and the second direction are perpendicular to each other, and the relief groove is defined on the middle plate portion,
the recessed groove comprises a first groove section and a second groove section, the first groove section is spaced apart from the relief groove in the first direction, and the first groove section is located between the relief groove and the heat dissipation fins on one side; an end of the second groove section is communicated with the first groove section, another end of the second groove section extends in the first direction and corresponds to the communicating hole near a corner of the base plate, and
the thru hole extends in the first direction to pass through an underside of the relief groove, and the thru hole communicates with the first groove section.

13. The detection assembly of claim 7, wherein
the mounting plate further comprises a second through-hole, the second through-hole is recessed from the bottom surface of the relief groove and extends through to the second surface, the second through-hole is spaced apart from the first through-hole,
the first circuit board further comprises a flame sensor for detecting a presence of a flame, the flame sensor is positioned on the substrate and corresponds to the second through-hole, and
the laser assembly further comprises a second lens, the second lens is positioned on a side of the second through-hole away from the laser generator, and the flame sensor corresponds to the second lens.

14. A laser assembly comprising:
the laser generator for emitting a laser;
the detection assembly of claim 1; and
a first lens, acting as the to-be-inspected lens, the first lens is located in the laser path of the laser generator, and the first lens is directly thermally or indirectly thermally coupled to the temperature sensor.

15. The laser assembly of claim 14, further comprises:
a cooling fan, connected to a side of the laser generator away from the detection assembly;
a circuit board connected to a side of the cooling fan away from the laser generator, the circuit board being electrically connected to the first circuit board, the circuit board receiving and processing temperature signals sent by the first circuit board, and the circuit board controlling the laser generator to emit the laser based on the temperature signals;
a top plate spaced apart from the circuit board and connected to a side of the circuit board away from the cooling fan; and
a shell surrounding a periphery of the circuit board, the cooling fan, the laser generator, and the detection assembly, an end of the shell being covered by the top plate.

16. The laser assembly of claim 15, wherein
the detection assembly further comprises a mounting plate, the mounting plate is connected to an emission side of the laser generator, and the mounting plate comprises a first through-hole allowing the laser to pass, the mounting plate further comprises an exposed portion, the exposed portion protrudes beyond a side of the laser generator,
an airflow channel is defined on the mounting plate, the airflow channel comprises an airflow inlet and an airflow outlet, the airflow inlet extends to a side of the exposed portion facing the laser generator, the airflow outlet communicates with the first through-hole,
the shell comprises a guide duct along an axial direction of the shell, one end of the guide duct communicates with the airflow channel, and another end of the guide duct is connected to a gas source, and
the laser assembly further comprises a nozzle, the nozzle comprises an axial hole, the nozzle is connected to a side of the mounting plate away from the laser generator and the axial hole corresponds to and communicates with the first through-hole, such that the laser is allowed to exit and an auxiliary laser processing gas is allowed to be sprayed through the airflow channel and the first through-hole.

17. The laser assembly of claim 16, wherein
the laser generator and the mounting plate are provided with heat dissipation fins, the heat dissipation fins define heat dissipation channels, the heat dissipation channels are parallel to a direction of the laser emission of the laser generator, and
an air intake is defined on the top plate, a ventilation gap is defined on the circuit board, the air intake communicates with the heat dissipation channels through the ventilation gap, and the cooling fan generates a cooling airflow that enters from the air intake and passes through the ventilation gap and the heat dissipation channels.

18. The laser assembly of claim 16, wherein
a portion of the shell corresponding to an exit of the laser is set as a protective observation window for observing emission of the laser and reducing an impact of the laser on eyes of an observer,
the circuit board comprises a power indicator light and a laser diode indicator light, the power indicator light indicates whether a normal power supply is available, the laser diode indicator light indicates whether a laser diode of the laser generator is emitting normally,
a lens status indicator light is positioned on the circuit board, the lens status indicator light indicates corresponding level of dirtiness of the first lens determined by the circuit board based on temperature information, and
the shell comprises an indicator light window, the indicator light window is made of a light-transmitting material and corresponds to the power indicator light, the laser diode indicator light, and the lens status indicator light.

19. The laser assembly of claim 18, wherein
a breach is defined on one side wall of the shell for exhausting gas generated during laser processing in a space surrounded by the shell and the mounting plate where the nozzle is located.

20. (canceled)

21. A laser processing equipment, comprising:
the laser assembly of claim 14, the laser assembly emitting cutting laser; and
a displacement assembly connected to the laser assembly and configured to drive the laser assembly to move.

22. (canceled)
